(19) United States
(12) Patent Application Publication
(10) Pub. No.: US 2005/0243772 A1
(43) Pub. Date: Nov. 3, 2005

(54) Handover supporting method and apparatus and handover method and apparatus

(75) Inventors: Jae-hwang Lee, Seoul (KR); Young-Keun Kim, Incheon (KR); Pyung-soo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co. Ltd., Suwon-si (KR)

(21) Appl. No.: 11/115,309

(22) Filed: Apr. 27, 2005

(30) Foreign Application Priority Data
Apr. 28, 2004 (KR) 10-2004-0029545

(51) Int. Cl. H04Q 7/00

(52) U.S. Cl. 370/331; 370/338

(57) ABSTRACT

A handover supporting method and apparatus and a handover method and apparatus are provided. The handover supporting method includes generating a frame, which contains information necessary for generating an address of the first access point; and transmitting the frame to the second access point. Accordingly, access points can communicate with each other even during a handover triggered by movement of the mobile station between different subnets, i.e., even during a handover in an IP layer.

### CROSS-REFERENCE TO RELATED APPLICATION

This application claims the benefit of Korean Patent Application No. 10-2004-0029545, filed on Apr. 28, 2004, in the Korean Intellectual Property Office, the disclosure of which is incorporated herein in its entirety by reference.

### BACKGROUND OF THE INVENTION

1. Field of the Invention

The present invention relates to a handover apparatus and method, which perform a handover in a wireless LAN environment, and more particularly, to a handover apparatus and method, which perform a handover in an IEEE 802.11 wireless LAN environment.

2. Description of the Related Art

In recent years, the number of subscribers for mobile communication services has dramatically increased. In accordance with the commercialization of mobile communication services that support multimedia communications, the demand for seamless communications has become stronger. In addition, more attention has been drawn to a handover in an IEEE 802.11-based wireless LAN environment.

FIG. 1 is a diagram illustrating a conventional wireless LAN environment. Referring to FIG. 1, the conventional wireless LAN environment includes a mobile station 1, a first access point 21, a second access point 22, a third access point 23, a fourth access point 24, a first access router 31, and a second access router 32.

In FIG. 1, it is assumed that the mobile station 1 sequentially moves from a cell managed by the first access point 21 to a cell managed by the second access point 22, from the cell managed by the second access point 22 to a cell managed by the third access point 23, and from the cell managed by the third access point 23 to a cell managed by the fourth access point 24. In the IEEE 802.11 standard, the term “basic service set (BSS)” is used instead of “cell”.

The first access point 21 and the second access point 22 are connected to the first access router 31, and the third access point 23 and the fourth access point 24 are connected to the second access router 32. The first access router 31 manages a first subnet, and the second access router 32 manages a second subnet. Accordingly, the mobile station 1 moves from the first subnet to the second subnet.

The first through fourth access points 21 through 24 periodically transmit beacon frames indicating their respective cells to the mobile station 1, which is on the move, in order to let the mobile station 1 know via which one of them the mobile station 1 can access a wired network. This type of operation is called passive scan. Alternatively, the mobile station 1 may transmit a probe request frame to know via which one of the first through fourth access points 21 through 24 it can access the wired network, in which case any of the first through fourth access points 21 through 24 that receives the probe request frame from the mobile station 1 and transmits a probe response frame to the mobile station 1. This type of operation is called active scan.

The mobile station 1 receives a beacon frame or a probe response frame from the first access point 1 via a communication path 211 and then recognizes that it is currently located in the cell managed by the first access point 21 based on information recorded in the received beacon frame or probe response frame.

Thereafter, the mobile station 1 receives a beacon frame or probe response frame from the second access point 22 via a communication path 212 and then recognizes that its location has changed from the cell managed by the first access point 21 to the cell managed by the second access point 22 based on information recorded in the received beacon frame or probe response frame. Thereafter, the mobile station 1 transmits a re-association request frame to the second access point 22 via the communication path 212 in order to be handed over from the cell managed by the first access point 21 to the cell managed by the second access point 22, and the second access point 22 receives the re-association request frame from the mobile station 1. The second access point 22 transmits a re-association response frame to the mobile station 1 via the communication path 212 in response to the receipt of the re-association request frame, and the mobile station 1 receives the re-association response frame from the second access point 22.

In order to perform a handover, the second access point 22 should transmit a handover request frame to the first access point 21 according to an inter-access point protocol (IAPP). The IAPP is designed based on a user datagram protocol/Internet protocol so that it can be applied to various types of wired or wireless networks. In order to communicate with the first access point 21, the second access point 22 should take advantage of a routing service on an IP layer. Given all this, the second access point 22 must know an IP address of the first access point 21 in order to transmit the handover request frame to the first access point 21.

A link layer address of the first access point 21 is recorded in a current access point address field of the re-association request frame transmitted from the mobile station 1 that has just moved into the cell managed by the second access point 22. The second access point 22 obtains the IP address of the first access point 21 by using a reverse address resolution protocol (RARP) with reference to the link layer address of the first access point 21, which is recorded in the current access point address field of the re-association request frame received from the mobile station 1. The RARP is a protocol that helps the second access point 22 to dynamically obtain the IP address of the first access point 21 from the link layer address of the first access point 21. The second access point 22 transmits the handover request frame to the first access point 21 via communication paths 322 and 321 by using the obtained IP address of the first access point 21 as a destination address, and the first access point 21 receives the handover request frame from the second access point 22. Thereafter, the first access point 21 transmits a handover response frame to the second access point via the communication paths 322 and 321, and the second access point 22 receives the handover response frame from the first access point 21.

As described above, access points in the different cells can communicate with each other in a handover triggered by movement of the mobile station 1 between different cells, i.e., in a handover in a link layer. According to an open systems interconnection reference model, the link layer corresponds to a second layer or a L2 layer. Thus, a handover in the link layer is called L2 handover.

Thereafter, the mobile station 1 receives a beacon frame or probe response frame from the second access point 22 via a communication path 213 and then recognizes that it is current located in the cell managed by the second access point 22 based on information recorded in the received beacon frame or probe response frame.

Thereafter, the mobile station 1 receives a beacon frame or probe response frame from the third access point 23 via a communication path 214 and then recognizes that its location has changed from the cell managed by the second access point 22 to the cell managed by the third access point 23 based on information recorded in the received beacon frame or probe response frame. Thereafter, the mobile station 1 transmits a re-association request frame to the third access point 23 via the communication path 214 in order to be handed over from the cell managed by the second access point 22 to the cell managed by the third access point 23, and the third access point 23 receives the re-association request frame from the mobile station 1. The third access point 23 transmits a re-association response frame to the mobile station 1 via the communication path 214 in response to the receipt of the re-association request frame, and the mobile station 1 receives the re-association response frame from the third access point 23.

In order to transmit a handover request frame to the second access point 22, the third access point 23 should know an IP address of the second access point 22. A link layer address of the second access point 22 is recorded in a current access point address field of the re-association request frame transmitted from the mobile station 1 that has just moved into the cell managed by the third access point 23. However, since the third access point 23 belongs to a different subnet from the second access point 22, the third access point 23 cannot obtain the IP address of the second access point 22 in the same manner as the second access point 22. More specifically, the first through fourth access points 21 through 24 have RARP tables, which associates link layer addresses with IP addresses. The RARP tables of the first through fourth access points 21 through 24 only have information on the respective subnets. Therefore, the RARP table of the third access point 23 only has information on the second subnet. Thus, the third access point 23 cannot obtain the IP address of the second access point 22 by using its RARP table with reference to the link layer address of the second access point 22. Accordingly, the third access point 23 cannot communicate with the second access point 22 since the third access point 23 fails to obtain the IP address of the second access point 22.

As described above, access points cannot communicate with each other in a handover triggered by movement of a mobile station between different subnets, i.e., in a handover in an IP layer. According to the OSI reference model, the IP layer corresponds to a third layer or a L3 layer. Thus, a handover in the IP layer is called L3 handover.

An operation performed when the mobile station 1 receives a beacon frame or probe response frame from the third or fourth access point 23 or 24 via the communication path 214 or a communication path 216 is the same as the operation performed when the mobile station 1 receives the beacon frame or probe response frame from the first or second access point 21 or 22 via the communication path 211 or 212. In other words, the fourth access point 24 transmits a handover request frame to the third access point 23 via a communication path 324 or 323, and the third access point 23 receives the handover request frame. Consequently, in the prior art, access points cannot communicate with each other in a L3 handover, even though they can communicate with each other in a L2 handover.

### SUMMARY OF THE INVENTION

Additional aspects and/or advantages of the invention will be set forth in part in the description which follows and, in part, will be obvious from the description, or may be learned by practice of the invention.

The present invention provides a handover supporting apparatus and method and a handover apparatus and method, which can enable access points to communicate with each other even in a L3 handover triggered by movement of a mobile station between different subnets.

The present invention also provides a computer-readable recording medium, on which a program enabling the handover supporting method or the handover method is recorded.

According to an aspect of the present invention, there is provided a handover supporting method, which supports a handover of a mobile station from a first subnet where a first access point is located to a second subnet where a second access point is located. The handover supporting method includes generating a frame, which contains information necessary for generating an address of the first access point; and transmitting the frame to the second access point.

According to another aspect of the present invention, there is provided a handover supporting apparatus, which supports a handover of a mobile station from a first subnet where a first access point is located to a second subnet where a second access point is located. The handover supporting apparatus includes a frame generation unit, which generates a frame, the frame containing information necessary for generating an address of the first access point; and a frame transmission unit, which transmits the frame to the second access point.

According to another aspect of the present invention, there is provided a handover method, which performs a handover of a mobile station from a first subnet where a first access point is located to a second subnet where a second access point is located. The handover method includes generating an address of the first access point by using information recorded in a frame received from the mobile station, the mobile station moving from the first subnet to the second subnet; and transmitting a handover request frame to the first access point using the destination address.

According to another aspect of the present invention, there is provided a handover apparatus, which performs a handover of a mobile station from a first subnet where a first access point is located to a second subnet where a second access point is located. The handover apparatus includes an address generation unit, which generates an address of the first access point by using information recorded in a frame received from the mobile station, the mobile station moving from the first subnet to the second subnet; and a frame transmission unit, which transmits a handover request frame to the first access point by using the address generated by the address generation unit as a destination address.

According to another aspect of the present invention, there is provided a computer-readable recording medium, on which a program enabling the handover supporting method is recorded.

According to another aspect of the present invention, there is provided a re-association request frame, which is transmitted to a second access point by a mobile station in order to generate an address of a first access point. The re-association request frame includes a field having a link layer address of the first access point a network prefix of a first subnet.

### BRIEF DESCRIPTION OF THE DRAWINGS

These and/or other aspects and advantages of the invention will become apparent and more readily appreciated from the following description of the embodiments, taken in conjunction with the accompanying drawings of which:

The above and other features and advantages of the present invention will become more apparent by describing in detail exemplary embodiments thereof with reference to the attached drawings in which:

FIG. 1 is a diagram illustrating a conventional wireless LAN environment;

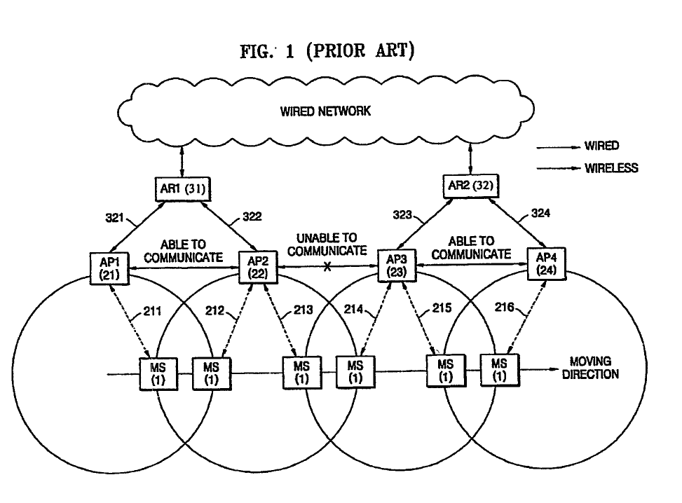

FIG. 2 is a diagram illustrating a wireless LAN environment according to an exemplary embodiment of the present invention;

FIG. 3 is a block diagram illustrating a handover supporting apparatus according to an exemplary embodiment of the present invention;

FIG. 4 is a diagram illustrating the format of a re-association request frame according to an exemplary embodiment of the present invention;

FIG. 5 is a flowchart illustrating a handover supporting method according to an exemplary embodiment of the present invention;

FIG. 6 is a block diagram illustrating a handover apparatus according to an exemplary embodiment of the present invention; and

FIG. 7 is a flowchart illustrating a handover method according to an exemplary embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention will now be described more fully with reference to the accompanying drawings, in which exemplary embodiments of the invention are shown.

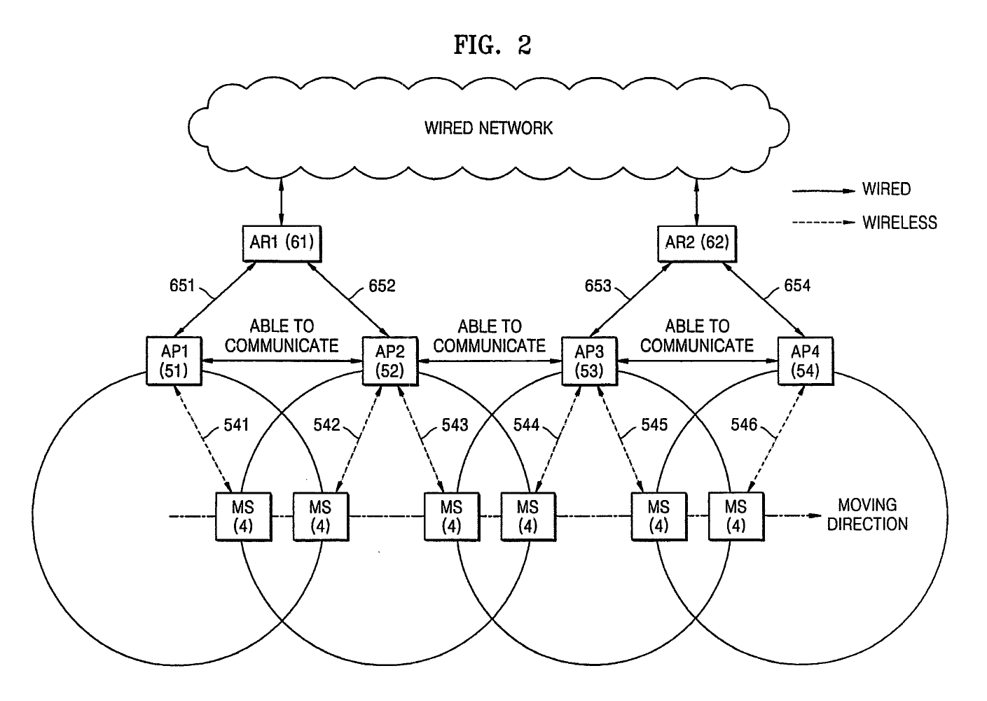

FIG. 2 is a diagram illustrating a wireless LAN environment according to an exemplary embodiment of the present invention. Referring to FIG. 2, the wireless LAN environment includes a mobile station 4, a first access point 51, a second access point 52, a third access point 53, a fourth access point 54, a first access router 61, and a second access router 62.

Here, it is assumed that the mobile station 4 sequentially moves from a cell managed by the first access point 51 to a cell managed by the second access point 52, from the cell managed by the second access point 52 to a cell managed by the third access point 53, and from the cell managed by the third access point 53 to a cell managed by the fourth access point 54.

The first access point 51 and the second access point 52 are connected to the first access router 61, and the third access point 53 and the fourth access point 54 are connected to the second access router 62. The first access router 61 manages a first subnet, and the second access router 62 manages a second subnet. Accordingly, the mobile station 4 moves from the first subnet to the second subnet.

When the mobile station 4 moves into the range of access point 53, the mobile station 4 receives a beacon frame or probe response frame from the third access point 53 via a communication path 544 and then recognizes that its location has been changed from the cell managed by the second access point 52 to the cell managed by the third access point 53 based on information recorded in the received beacon frame or probe response frame. Thereafter, in order to be handed over from the cell managed by the second access point 52 to the cell managed by the third access point 53, the mobile station 4 transmits a re-association request frame to the third access point 52 via the communication path 544 by referring to the information recorded in the received beacon frame or probe response frame. The third access point 53 receives the re-association request frame from the mobile station 4. Thereafter, the third access point 53 transmits a re-association response frame to the mobile station 4 in response to the receipt of the re-association request frame, and then the mobile station 4 receives the re-association response frame.

The re-association request frame contains predetermined information necessary for generating an IP address of the second access point 52. The third access point 53 generates an IP address of the second access point 52 using the predetermined information contained in the re-association request frame. Then, the third access point 53 transmits a handover request frame to the second access point 52 via communication paths 653 and 652 by using the generated IP address of the second access point 52, and the second access point 52 receives the handover request frame from the third access point 53. In short, the second and third access points 52 and 53 are enabled to communicate with each other even during a L3 handover by containing the predetermined information necessary for generating the IP address of the second access point 52 in the handover request frame transmitted from the second access point 52.

The present invention can also be applied to an occasion when the mobile station 4 receives a beacon frame or probe response frame via a communication path 541, 542, 543, 545, or 546. Therefore, in the present invention, unlike in the prior art, there is no need to refer to a reverse address resolution protocol (RARP) table, thus realizing a fast handover.

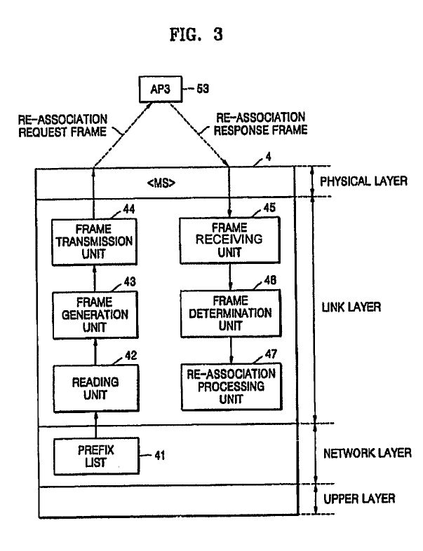

FIG. 3 is a block diagram illustrating a handover supporting apparatus according to an embodiment of the present invention. Referring to FIG. 3, the handover supporting apparatus includes a reading unit 42, a frame generation unit 43, a frame transmission unit 44, a frame receiving unit 45, a frame determination unit 46, and a re-association processing unit 47. The handover supporting apparatus is mounted in a link layer of the mobile station 4 of FIG. 2 and supports a handover between access points.

A prefix list 41 stores a network prefix of the first subnet, in which the mobile station 4 is currently located. As shown in FIG. 3, the prefix list 41 is mounted in a network layer of the mobile station 4 and is a term used in the IPv6 standard. According to the IPv6 standard, the first access router 61, which manages the first subnet, transmits a router advertisement message containing the network prefix of the first subnet if it receives a router solicitation message. Thereafter, if the mobile station 4 receives the router advertisement message, the prefix list 41 stores the network prefix of the first subnet contained in the router advertisement message.

The reading unit 42 reads the network prefix of the first subnet, in which the mobile station 4 is currently located, from the prefix list 41.

The frame generation unit 44 generates a re-association request frame containing predetermined information, which is necessary for generating an address of the second access point 22. Here, the address of the second access point 22 is an IP address, which is a network layer address of the second access point 22 in the first subnet. In other words, the frame generation unit 44 generates the re-association request frame containing predetermined information, which is necessary for generating a network layer address of the second access point 52.

The IPv6 standard has suggested “address auto-configuration”, which is a new protocol that enables the mobile station 4 to generate its own IP address by itself. According to “address auto-configuration”, the mobile station 4 generates its own IP address by combining a network prefix of a subnet, in which it is currently located, with its link layer address. Therefore, the predetermined information necessary for generating the IP address of the second access point 52 is the link layer address of the second access point 52 and the network prefix of the first subnet read by the reading unit 42.

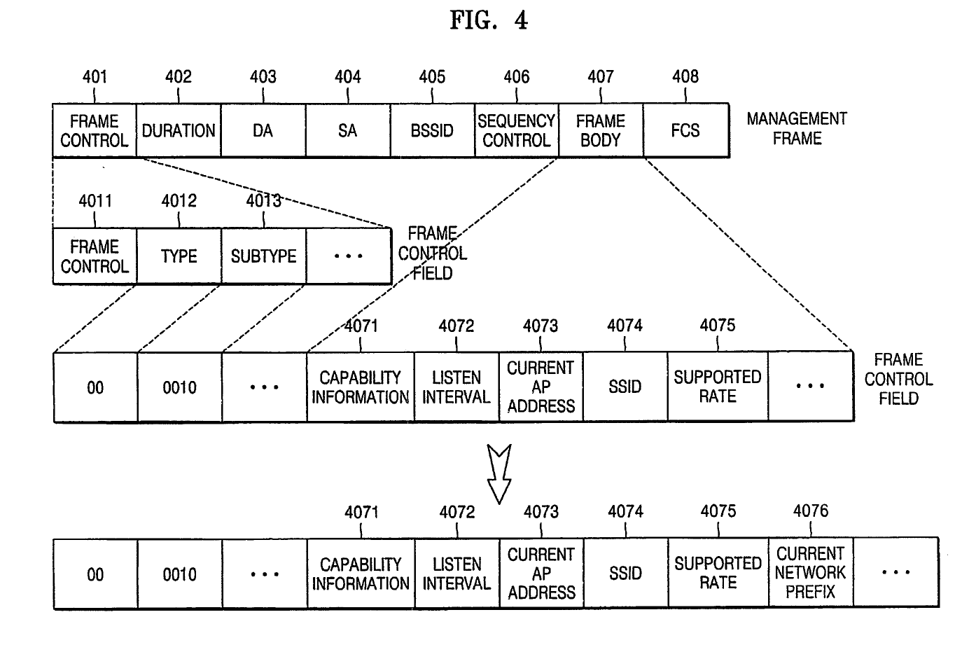

FIG. 4 is a diagram illustrating the format of a re-association request frame according to an embodiment of the present invention. Referring to FIG. 4, an IEEE 802.11-based management frame includes a frame control field 401, a duration field 402, a destination address field 403, a source address field 404, a basic service set (BSS) identification field 405, a sequence control field 406, a frame body field 407, and a frame check sequence field 408.

The IEEE 802.11-based management frame except for the frame body field 407 and the frame check sequence field 408 is called a media access control (MAC) header. The frame control field 401 of the MAC header includes a protocol version field 4011, a type field 4012, a subtype field 4013, and other fields.

According to the IEEE 802.11 standard, the re-association request frame is a type of management frame whose subtype field (4013) has a value of 0010. When the type field 4012 has a value “0”, the re-association request frame is considered a management frame. The frame body field 407 includes a capability information field 4071, a listen interval field 4072, a current access point address field 4073, a service set identification field 4074, and a supported rates field 4075.

In the capability information field 4071, information on the capability of a mobile station is recorded. In the listen interval field 4072, at what intervals the mobile station is awoken from a low power mode to receive a frame from an access point is recorded. In the current access point address field 4073, a link layer address of an access point that manages a cell, in which the mobile station is currently located, is recorded. In the service set identification field 4074, identification of an extended service set (ESS), in which the mobile station is currently located, is recorded. The ESS is a set of BSSs, i.e., a set of cells, and defines the range of a wireless LAN in a link layer. Thus, the ESS is different from a subnet, which defines the range of a wireless LAN in a network layer. In the supported rates field 4075, rates supported by the mobile station are recorded.

As described above, in order to generate the IP address of the second access point 52, the third access point 53 should have the link layer address of the second access point 52 and the network prefix of the first subnet. However, according to the IEEE 802.11 standard, the re-association request frame includes the current access point address field 4073 but does not include a field, in which the network prefix of the first subnet is recorded.

Therefore, the present invention suggests a new re-association request frame, which includes not only all of the fields of an existing IEEE 802.11-based re-association request frame but also a field, in which the network prefix of the first subnet is recorded, i.e., a current network prefix field 4076. The frame generation unit 43 generates the new re-association request frame by adding the current network prefix field 4076 to the existing IEEE 802.11-based re-association request frame.

Referring back to FIG. 3, the frame transmission unit 44 transmits the re-association request frame generated by the frame generation unit 43 to the third access point 53. More specifically, the frame transmission unit 44 transmits a re-association request frame, in which a link layer address of the third access point 53 is recorded in a destination address field of a MAC header, to the third access point 53.

The frame receipt unit 45 receives an arbitrary frame from the third access point 53, which manages the cell, in which the mobile station 4 is currently located. More specifically, the frame receipt unit 45 checks a destination address field of a MAC header of the frame received from the third access point 53 and outputs the received frame to the frame determination unit 46 if a link layer address of the mobile station 4 is recorded in the destination address field of the MAC header of the received frame.

The frame determination unit 46 determines whether the frame received from the frame receipt unit 45 is a re-association response frame, which is a response to the re-association request frame generated by the frame generation unit 43. More specifically, the frame determination unit 46 checks a type field and a subtype field of the received frame and determines that the received frame is the re-association response frame if the type field has a value “0” and the subtype field has a value “0011”. It is understandable that the values may be changed according to a predetermined rule. The re-association response field, unlike the re-association request field generated by the frame generation unit 43, may be a typical IEEE 802.11-based re-association response frame, and thus its detailed description will be skipped.

If the frame received by the frame receipt unit 45 is determined as being the re-association response frame, the re-association processing unit 47 attempts re-associate the mobile station 4 with the third access point 53 based on information recorded in the re-association response frame. More specifically, the re-association processing unit 47 establishes information, which is necessary for the mobile station 4 to communicate with the third access point 53 when re-associated with the third access point 53, by using the information recorded in the re-association response frame.

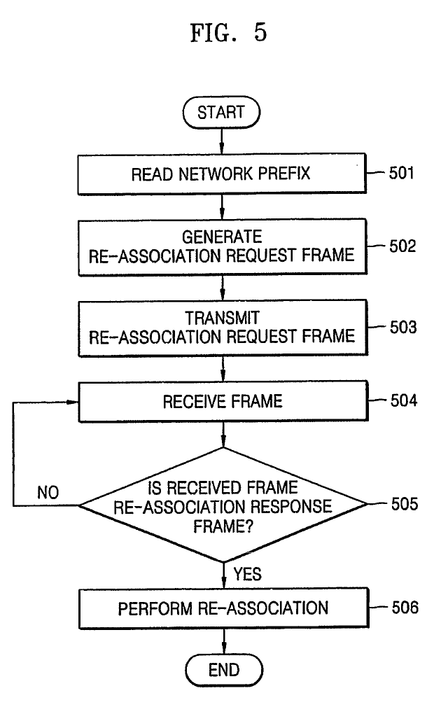

FIG. 5 is a flowchart illustrating a handover supporting method according to an embodiment of the present invention. Referring to FIG. 5, the handover supporting method is performed in the handover supporting apparatus of FIG. 3, and thus the above description of the handover supporting apparatus of FIG. 3 can be directly applied to the handover supporting method.

In operation 501, a network prefix of a first subnet is read from an IPv6-based prefix list.

In operation 502, a re-association request frame containing predetermined information is generated. Here, the predetermined information is necessary for generating an address of the second access point 52, and the address of the second access point 52 is an IP address, which is a network layer address of the second access point 52 in the first subnet. In short, in operation 502, the re-association request frame is generated in a link layer. The predetermined information includes a link layer address of the second access point 52 and the network prefix of the first subnet read in operation 501. More specifically, the re-association request frame is generated in operation 502 by adding a current network prefix field 4076, in which the network prefix of the first subnet is recorded, to an existing IEEE 802.11-based re-association request frame, which only includes the link layer address of the second access point 52.

In operation 503, the re-association request frame generated in operation 502 is transmitted to the third access point 53.

In operation 504, frame is received from the third access point 53, which manages a cell, in which the mobile station is currently located.

In operation 505, it is determined whether the received frame is a re-association response frame.

In operation 506, if the received frame is determined as being the re-association response frame, the mobile station 4 is re-associated with the third access point 53 by using information recorded in the received frame.

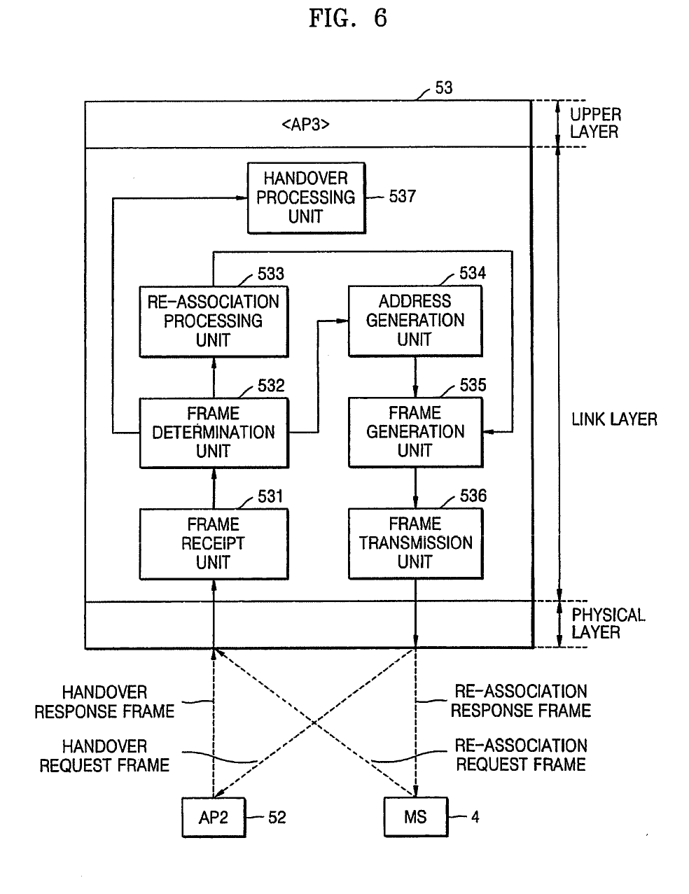

FIG. 6 is a diagram illustrating a handover apparatus according to another embodiment of the present invention. Referring to FIG. 6, the handover apparatus includes a frame receipt unit 531, a frame determination unit 532, a re-association processing unit 533, an address generation unit 534, a frame transmission unit 536, and a handover processing unit 537. The handover apparatus is mounted in a link layer of the third access point 53 of FIG. 2 and performs a handover for the second access point 52.

The frame receipt unit 531 receives frame from the mobile station 4, which is currently located in a cell managed by the third access point 53. More specifically, the frame receipt unit 531 checks a destination address field of a MAC header of the received frame and outputs the received frame to the frame determination unit 532 if a value recorded in the destination address field of the MAC header of the received frame indicates a link layer address of the third access point 53.

The frame determination unit 532 determines whether the frame received by the frame receipt unit 531 is a re-association request frame containing predetermined information necessary for generating an address of the second access point 52. More specifically, the frame determination unit 532 checks a type field and a subtype field of the received frame and determines that the received frame is the re-association request frame if the type field has a value “0” and the subtype field has a value “0010.” Here, the predetermined information necessary for generating the address of the second access point 52 includes a link layer address of the second access point 52 and a network prefix of the first subnet. In the present embodiment, the re-association request frame is generated by adding a current network prefix field, in which the network prefix of the first subnet is recorded, to an existing IEEE 802.11-based re-association request frame.

If the frame received by the frame receipt unit 531 is determined as being the re-association request frame, the address generation unit 534 generates the address of the second access point 52 using information recorded in the corresponding frame, i.e., the link layer address of the second access point 52 and the network prefix of the first subnet. Here, the address of the second access point 52 is an IP address, which is a network layer address of the second access point 52 in the first subnet. In other words, the address generation unit 534 generates the network link layer of the second access point 52 in a link layer.

If the frame received by the frame receipt unit 531 is determined as being the re-association request frame, the re-association processing unit 533 re-associates the mobile station 4 with the third access point 53 based on the information recorded in the re-association request frame. More specifically, the re-association processing unit 533 establishes information, which is necessary for the mobile station 4 to communicate with the third access point 53 when re-associated with the third access point 53, by using the information recorded in the frame received by the frame receipt unit 531.

When the mobile station 4 is re-associated with the third access point 53 by the re-association processing unit 533, the frame generation unit 535 generates a re-association response frame containing information on the re-association of the mobile station 4 with the third access point 53.

The frame transmission unit 536 transmits the re-association response frame generated by the frame generation unit 535 to the mobile station 4. The re-association response frame has a MAC header, in which a link layer address of the mobile station 4 is recorded in a destination address field.

The frame generation unit 535 generates a handover request frame with the address generated by the address generation unit 534 set as a destination address. The handover request frame, unlike the re-association request frame suggested by the present invention, may be a typical handover request frame, which has already been suggested or is yet to be suggested by IAPP. Thus, a detailed description of the handover request frame will be skipped. However, since the address generated by the address generation unit 534 is an IP address, the frame generation unit 535 generates the handover request frame so that the address generated by the address generation unit 534 can be recorded in a destination address field of an IP header of the handover request frame.

The frame transmission unit 536 transmits the handover request frame to the second access point 52. The link layer address of the mobile station 4 is recorded in a destination address field of a MAC header of the handover request frame, and an IP address of the mobile station 4 is recorded in the destination address field of the IP header of the handover request frame. The second access router 62 and the first access router 61 route the handover request frame to the second access point, which is a final destination, by referring to the IP address of the mobile station 4 contained in the handover request frame.

The frame determination unit 532 determines whether the frame received from the mobile station 4 is a handover response frame, which is a response to the handover request frame transmitted from the frame transmission unit 536.

If the frame received from the mobile station 4 is determined as being the handover response frame, the handover processing unit 537 performs a handover for the second access point 52 by referring to information recorded in the handover response frame. More specifically, if the information recorded in the handover response frame indicates that the handover for the second access point 52 has been successfully performed, the handover processing unit 537 performs a handover for the second access point according to IAPP.

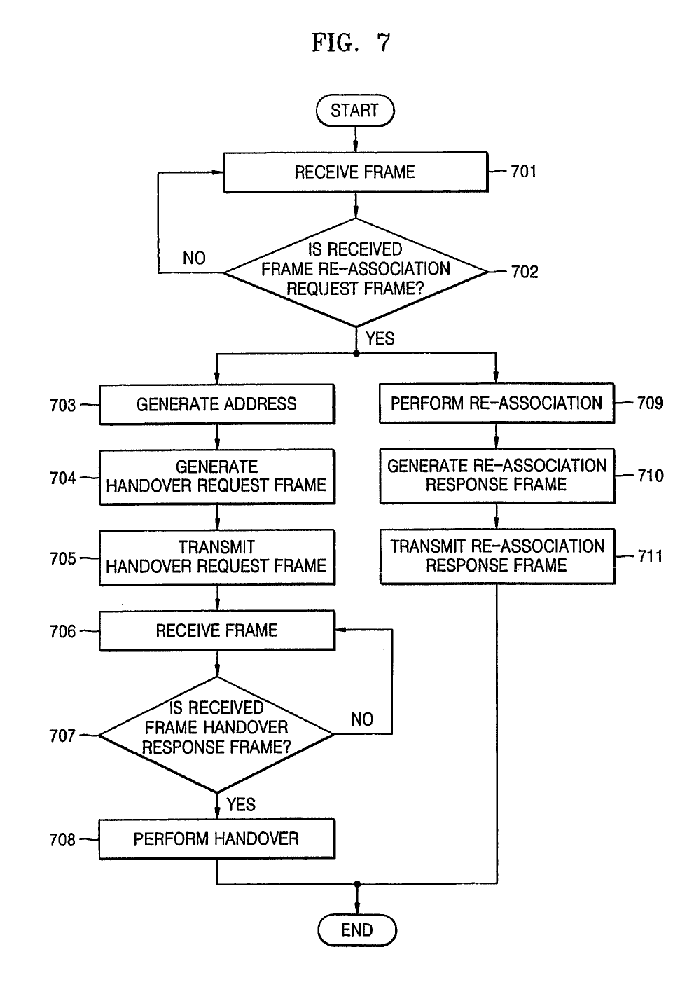

FIG. 7 is a flowchart of a handover method according to an embodiment of the present invention. Referring to FIG. 7, the handover method is performed in the handover apparatus of FIG. 6, and thus the above description of the handover apparatus of FIG. 6 can be directly applied to the handover method.

In operation 701, the frame is received from the mobile station 4, which is currently located in the cell managed by the third access point 53.

In operation 702, it is determined whether the frame is a re-association request frame containing predetermined information. Here, the predetermined information is necessary for generating an address of the second access point 52 and includes a link layer address of the second access point 52 and a network prefix of the first subnet. In other words, the re-association request frame generated by adding a current network prefix field, in which the network prefix of the first subnet is recorded, to an existing IEEE 802.11-based re-association request frame.

If the frame is determined as being the re-association request frame, the address of the second access point 52 is generated in operation 703 by using information recorded in the frame, i.e., the link layer address of the second access point 52 and the network prefix of the first subnet. Here, the address of the second access point 52 is an IP address, which is a network layer address of the second access point 52 in the first subnet. Therefore, in operation 703, the network layer address of the second access point 52 is generated in a link layer.

In operation 704, a handover request frame is generated with the address generated in operation 703 set as a destination address.

In operation 705, the handover request frame is transmitted to the second access point 52.

In operation 706, the frame is received from the second access point 52.

In operation 707, the frame received in operation 706 is a handover response frame, which is a response to the handover request frame transmitted in operation 705.

If the frame received in operation 706 is determined as being the handover response frame, a handover of the mobile station 4 is performed by using information recorded in the handover response frame.

If the frame received in operation 701 is determined as being the re-association request frame in operation 702, the mobile station 4 is re-associated with the third access point 53 by using the information recorded in the re-association request frame in operation 709.

If the mobile station 4 is successfully re-associated with the third access point 53 in operation 709, a re-association response frame containing information on the re-association of the mobile station 4 with the third access point 53 is generated.

In operation 711, the re-association response frame is transmitted to the mobile station 4.

The above embodiments of the present invention may be realized as computer programs, and the computer programs may be executed by using a common digital computer with the help of a computer-readable recording medium.

Data structures used in the above exemplary embodiments of the present invention may be recorded on a computer-readable recording medium in a variety of manners.

The computer-readable recording medium includes a magnetic storage medium (e.g., a ROM, a floppy disk, or a hard disk), an optical storage medium (e.g., a CD-ROM or a DVD), and a carrier wave (e.g., data transmission through the Internet).

According to the present invention, it is possible to enable access points to communicate with each other in a handover triggered by movement of a mobile station between different subnets, i.e., a handover in an IP layer, by containing information necessary for generating an address of a previous access point in a re-association request frame.

In addition, in the present invention, the address of the previous access point is generated by only referring to information recorded in the re-association request frame without the need to refer to an RARP table. Accordingly, it is possible to realize a fast handover. Moreover, such effect of the present invention is more apparent in application programs that provide real-time services, such as voice over Internet protocol (VoIP).

Furthermore, in the present invention, a field of an IEEE 802.11-based management frame that did not used to be used in the prior art is used. Therefore, the present invention is completely compatible with existing wireless LAN devices. In other words, there is no need to modify the existing wireless LAN devices or replace them with new ones in order to make them compatible with the present invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

Although a few embodiments of the present invention have been shown and described, it would be appreciated by those skilled in the art that changes may be made in these embodiments without departing from the principles and spirit of the invention, the scope of which is defined in the claims and their equivalents.

1. A handover supporting method, which supports a handover of a mobile station from a first subnet where a first access point is located to a second subnet where a second access point is located, the handover supporting method comprising:
generating a frame, which contains information necessary for generating an address of the first access point; and
transmitting the frame to the second access point.

2. The handover supporting method of claim 1, wherein the address of the first access point is a network layer address of the first access point in the first subnet, and, the frame is generated in a link layer.

3. The handover supporting method of claim 2, wherein the address of the first access point is an IP address, and the information necessary for generating the address of the first access point comprises a link layer address of the first access point and a network prefix of the first subnet.

4. The handover supporting method of claim 2, the frame further comprises:
a network prefix field of the first subnet.

5. The handover supporting method of claim 4, wherein the frame is on IEEE.802.11 based re-association request frame.

6. The handover supporting method of claim 1 further comprising:
reading the network prefix of the first subnet from prefix list,
wherein the frame containing the network prefix of the first subnet.

7. The handover supporting method of claim 1 further comprising:
determining whether a frame received from the second access point is a response to the frame; and
re-associating the mobile station with the second access point using information recorded in the frame received from the second access point if the frame received from the second access point is a response frame.

8. A handover supporting apparatus, which supports a handover of a mobile station from a first subnet where a first access point is located to a second subnet where a second access point is located, the handover supporting apparatus comprising:
a frame generation unit, to generate a frame, where is the frame containing information necessary to generate an address of the first access point; and
a frame transmission unit, for transmitting the frame to the second access point.

9. The handover supporting apparatus of claim 8, wherein the address of the first access point is a network layer address of the first access point in the first subnet, and the frame generation unit generates the frame in a link layer.

10. A handover method, which performs a handover of a mobile station from a first subnet where a first access point is located to a second subnet where a second access point is located, the handover method comprising:
generating an address of the first access point using information recorded in a frame received from the mobile station, the mobile station moving from the first subnet to the second subnet; and
transmitting a handover request frame to the first access point using the address as a destination address.

11. The handover method of claim 10, wherein the address of the first access point is a network layer address of the first access point in the first subnet and the network layer address of the first access point is generated in a link layer.

12. The handover method of claim 10, wherein the address of the first access point is an IP address, and the information necessary for generating the address of the first access point comprises a link layer address of the first access point and a network prefix of the first subnet.

13. The handover method of claim 10, wherein, the frame having a network prefix field of the first subset.

14. The handover method of claim 10, wherein the frame comprises a re-association request frame.

15. The handover method of claim 14, wherein the re-association request frame is based upon IEEE.802.

16. The handover method of claim 10, further comprising:
determining whether the frame received from the mobile station is a frame containing information necessary for generating the address of the first access point.

17. The handover method of claim 10, further comprising:
determining whether a frame received from the first access point is a response to the handover request frame transmitted from the frame transmission unit; and
performing a handover of the mobile station from the first subnet to the second subnet by using information recorded in the frame received from the first access point if the frame received from the first access point is determined to be a response to the handover request frame transmitted from the frame transmission unit.

18. A handover apparatus, which performs a handover of a mobile station from a first subnet where a first access point is located to a second subnet where a second access point is located, the handover apparatus comprising:
an address generation unit, which generates an address of the first access point by using information recorded in a frame received from the mobile station, the mobile station moving from the first subnet to the second subnet; and
a frame transmission unit, which transmits a handover request frame to the first access point using the address generated by the address generation unit as a destination address.

19. The handover apparatus of claim 18, wherein the address of the first access point is a network layer address of the first access point in the first subnet, and the address generation unit generates the network layer address of the first access point in a link layer.

20. A computer-readable recording medium, on which a program enabling the handover supporting method of claim 1 is recorded.

21. A computer-readable recording medium, on which a program enabling the handover method of claim 9 is recorded.

22. A re-association request frame, which is transmitted to a second access point by a mobile station in order to generate an address of a first access point, the re-association request frame comprising:
a field, in which a link layer address of the first access point is recorded; and
a field, in which a network prefix of a first subnet where the first access point is located is recorded.
